(19) United States
(12) Patent Application Publication
(10) Pub. No.: US 2003/0109314 A1
(43) Pub. Date: Jun. 12, 2003

(54) Handheld case gripper

(76) Inventor: Man To Ku, Arcadia, CA (US)

Correspondence Address: RAYMOND Y. CHAN, 1050 OAKDALE LANE, ARCADIA, CA, 91006, US

(21) Appl. No.: 10/006,571

(22) Filed: Dec. 6, 2001

(51) Int. Cl. A63F 13/00

(52) U.S. Cl. 463/47

(57) ABSTRACT

A handheld case gripper is adapted for detachably attaching to an electronic game device, which includes a supporting holder having a receiving cavity for fittedly sitting the electronic game device thereon and two handle members extended from a bottom of the supporting holder. An interlocking arrangement includes at least a locking means frontwardly extended from a sidewall of the receiving cavity for interlocking with an engagement groove of the electronic game device, so as to securely lock up the electronic game device on the supporting holder of the handheld case gripper. Moreover, the handheld case gripper comprises an audio device and a vibrating device for generating sound of any particular game of the electronic game device and vibration of the handheld case gripper respectively. With these arrangements, a player is able to firmly hold the electronic game device by holding the two handle members of the supporting holder within palms of the player's hands.

### BACKGROUND OF THE PRESENT INVENTION

1. Field of Invention

The present invention relates to an electronic game accessory, and more particularly to a handheld case gripper adapted for detachably attaching to an electronic game device, so as to enable a player to grip the electronic game device comfortably and to operate the electronic game device more effectively.

2. Description of Related Arts

For years, entertainment companies have provided tons of sophisticated electronic games which allow people to have more fun and exciting stimulation during leisure. Among them, a portable mini electronic game device has been enjoying extensive acceptance, in that it allows a player to play games everywhere and anytime.

The mini electronic game device generally comprises a case which contains electronic components therein. The case usually has a top panel, a bottom panel, a screen provided on the top panel, a plurality of main control buttons provided on the top panels, two side control buttons operatively provided at two upper corners of the case, and a card slot provided on top of the case for a game card selectively inserted thereto.

Due to the design of the mini electronic game device, the players normally use their thumbs to control the main control buttons and their index fingers to control the side control buttons. The rest of the supporting fingers are used to support underneath the case. In order to support the mini electronic game device in a stable manner, the players must use their fingers to grip the case. However, during playing games, a player has to move their thumbs and index fingers in order to control the mini game device, this may cause unwanted movement of the mini electronic game device to slip out of the player's hands. This situation is especially true for such player as a child who has relative smaller hands. Besides, the supporting fingers when gripped with the case of the mini electronic game device may affect the quick response movement of the thumbs and the index fingers, so that the players always feel uncomfortable and tired for a period of continued playing. In worse, an improper gripping position of the player may even hurt the player's hand, and especially the young child, permanently.

### SUMMARY OF THE PRESENT INVENTION

A main object of a handheld case gripper for electronic game device according to the present invention is for detachably attaching to an electronic game device by means of interlocking arrangement for the purpose of preventing any unwanted movement of the electronic game device during playing when it is mounted on the handheld case gripper.

Another object of the handheld case gripper for electronic game device according to the present invention is to provide a better gripping support to a player such that the player can securely hold the electronic game device, so as to prevent the electronic game device from being slip of the player's hand accidentally.

Another object of the handheld case gripper for electronic game device according to the present invention is that its innovative structure allows the players to grip the electronic game device more securely by the supporting fingers and to move the control fingers in a quick response manner without inducing much tiring to the players.

Another object of the handheld case gripper for electronic game device according to the present invention is to provide a rechargeable power supply for supplying power to the electronic game device.

Another object of the handheld case gripper for electronic game device according to the present invention is to provide an audio device for providing sound effect of any particular game of the electronic game device.

Another object of the handheld case gripper for electronic game device according to the present invention is to provide a vibrating device for generating vibration of the handheld case gripper so as to increase motion sensation and excitation of the player while the player is playing games of the electronic game device.

Accordingly, in order to accomplish the above objects, the present invention provides a handheld case gripper for detachably attaching to an electronic game device which comprises a casing having a top panel and a bottom panel wherein an engagement groove is defined between the top panel and the bottom panel, and two side control buttons provided on two top corners of the casing.

The handheld case gripper comprises a supporting holder, which has a receiving cavity defined thereon for fittedly receiving the electronic game device and comprises two handle members extended from a bottom of the supporting holder, whereby the player is able to firmly hold the electronic game device by holding the two handle members of the supporting holder within palms of the player's hands respectively.

The handheld case gripper further comprises an interlocking arrangement which comprises at least a locking device which is extended from a sidewall of the receiving cavity and interlocks with the engagement groove of the case, so as to securely lock up the case of the electronic game device on the supporting holder.

### BRIEF DESCRIPTION OF THE DRAWINGS

FIG. 1 is a perspective view illustrates a handheld case gripper with an electronic game device mounted thereon according to a preferred embodiment of the present invention.

FIG. 2 is a top perspective view of the handheld case gripper according to the above preferred embodiment of the present invention.

FIG. 3 is a bottom perspective view of the handheld case gripper according to the above preferred embodiment of the present invention.

FIG. 4 is a sectional bottom view of the handheld case gripper according to the above preferred embodiment of the present invention.

FIG. 5 is a side view of the handheld case gripper with the electronic game device attached thereon according to the above preferred embodiment of the present invention.

FIG. 6 is a sectional rear view of the handheld case gripper with the electronic game device attached thereon according to the above preferred embodiment of the present invention, illustrating the electrically connection of the terminal connector in the battery compartment.

FIG. 7 is a perspective view illustrates a handheld case gripper with an electronic game device mounted thereon according to an alternative mode of the above preferred embodiment of the present invention.

FIG. 8 is a side view of the handheld case gripper with the electronic game device attached thereon according to the above alternative mode of the preferred embodiment of the present invention.

### DETAILED DESCRIPTION OF THE PREFERRED EMBODIMENT

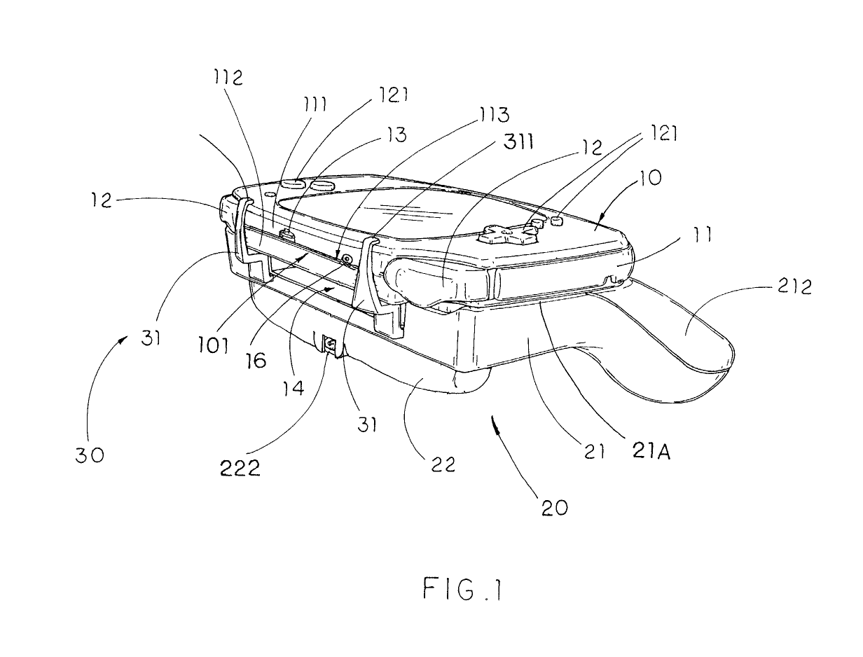

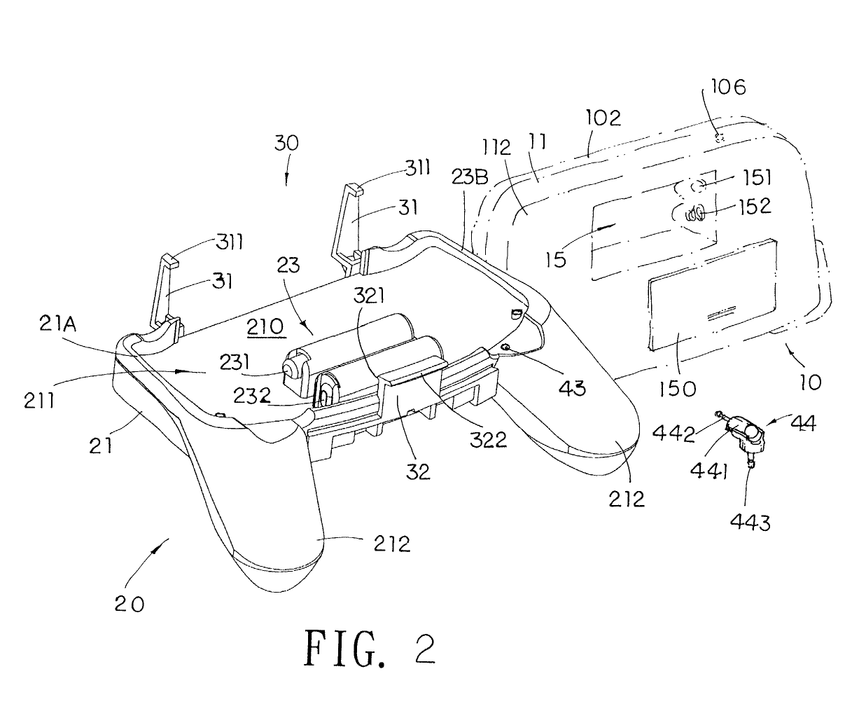

Referring to FIGS. 1-2 of the drawings, a handheld case gripper adapted for detachably attaching to all electronic game device 10 according to a preferred embodiment of the present invention is illustrated.

The electronic game device 10, as mentioned in the background, comprises a casing 11 having a top panel 111 and a bottom panel 112 sealedly attached to the top panel 111 wherein an engagement groove 113 is defined between the connecting edges of the top panel 111 and the bottom panel 112 and extended peripherally around the casing 11. The electronic game device 10 further comprises to side control buttons 12 and top control buttons 121 operatively provided on two top corners of the casing 11 and the top panel 111 respectively, a plurality of device outlets 13 provided on sides of the casing 11, a card slot 14 formed on a rear side of the casing 11 for a game card to insert therein, a battery compartment 15, having at least a conductive unit 151, for receiving batteries therein, and an audio output slot 16 for transmitting digital audio signal to external audio device, such as an earphone.

Referring to FIGS. 1 to 3 of the drawings, the handheld case gripper 20 comprises a supporting holder 21 has a supporting platform 210 at a top surface thereof and two U-shaped side holding rims 21A, 21B upwardly protruded from two peripheral sides of the supporting platform 210 to define a receiving cavity 211 between the two side holding rims 21A, 21B on top of the supporting platform 210 for fittedly receiving the electronic game device 10 therein, wherein the supporting platform 210 substantially supports the weight of the electronic game device 10.

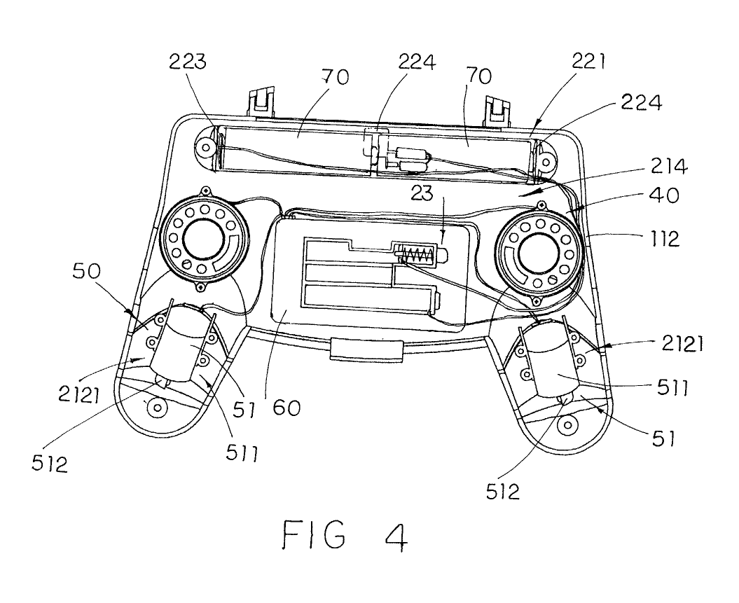

The supporting holder 21 further comprises two handle members 212 frontwardly and downwardly extended from a front portion of the supporting holder 21, and a gripping supports 22 downwardly extended from a rear portion of the supporting holder 21. The supporting platform 210 and a bottom panel 213 of the supporting holder 21 connects edge to edge together and forms a storage cavity 214 for partially storing at least one audio device 40 therein, as shown in FIG. 4, and that each of the handle members 212 has a handle cavity 2121 provided inside and communicated with the storage cavity 214.

The handheld case gripper further comprises a vibrating device 50 and a control board 60. The control board 60 is an electric circuit board or an IC board installed inside the storage cavity 214, as shown in FIG. 4. The vibrating device 50 comprises two vibrators 51 which are mounted in the two handle cavities 2121 respectively and electrically connected with the control board 60.

Generally, a player can firmly hold the electronic game device 10 by holding the two handle members 212 of the supporting holder 21 within palms of the player's hands and gripping the gripping support 92 by two middle fingers of the player's two hands respectively.

As shown in FIGS. 1, 2 and 5, the handheld case gripper 20 further comprises an interlocking arrangement 30 for holding the electronic game device 10 on top of the supporting holder 21 of the handheld case gripper 20. The interlocking arrangement 30 comprises at least a holder arm 31 integrally and upwardly extended from a rear sidewall of the supporting holder 21 and a locking gripper 32 integrally and upwardly extended from a front side wall of the supporting holder 21, so that the electronic game device 10 is firmly held in position between the holder arm 31 and the locking gripper 32 so as to securely grip the casing 11 of the electronic game device 10 on top of the supporting holder 21.

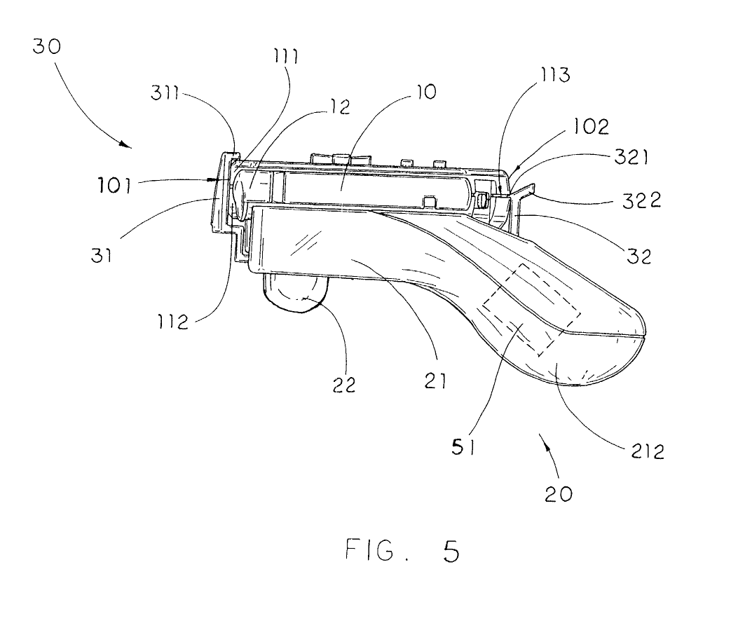

According to the preferred embodiment of the present invention, there is a pair of holder arms 31 provided at two end portions of the rear sidewall of the supporting holder 21, adapted for pressing against the rear side 101 of the casing 11 of the electronic game device 10 so as to prevent any rearward movement of the electronic game device 10. In which, the card slot 14 is maintained opened to communicate with outside between the two holder arms 31. On the other hand, with the two rear holder arms 31 biasing against the rear side 101 of the casing 11, the front locking gripper 32 is arranged to fittingly press against the front side 102 of the casing 11 for limiting any frontwardly movement of the electronic game device 10. Therefore, by engaging the two rear holder arms 31 and the front locking gripper 32 with the casing 11, the electronic game device 10 is securely mounted on the handheld case gripper 20 that prevents any unwanted movement of the electronic game device 10 with respect to the handheld case gripper 20, as shown in FIG. 5.

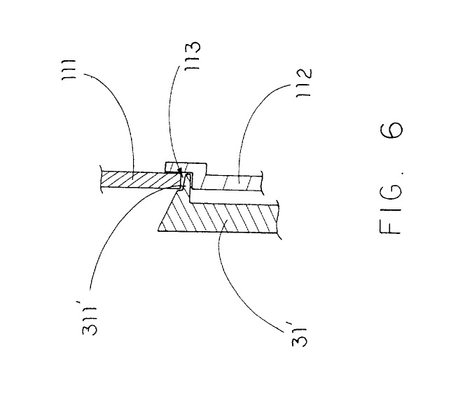

In order to securely lock up the casing 11 of the electronic game device 2 on the supporting holder 21 of the handheld case gripper 20, at least one of the locking gripper 32 is arranged to interlock with the engagement groove 113 of the casing 11, as shown in FIGS. 5 and 6. Moreover, the locking gripper 32, which has a predetermined width, is extended from a mid portion of the supporting holder 21 and adapted for engaging with the engagement groove 113 of the casing 11.

According to the first preferred embodiment of the present invention, the front locking gripper 32 is integrally extended from a front edge of the supporting holder 21 and a front locking ridge 321 is inwardly protruded from a top edge of the locking gripper 32 towards the rear holder arms 31. The thickness of the locking ridge 321 is slightly smaller than a width of the engagement groove 113 of the casing 11. Therefore, when the locking gripper 32 presses on the front side 102 of the casing 11, the locking ridge 321 also fittingly engages into the engagement groove 113 of the casing 11. By means of the engagement of the locking gripper 32 with the engagement groove 113 of the casing 11, the casing 11 is securely locked in position to prevent the casing 11 of the electronic game device 10 from lifting up from the supporting holder 21.

According to the preferred embodiment, each of the two holder arms 31 of the handheld case gripper 20 has an elastic ability and is integrally extended from a rear wall of the supporting holder 21 and provided with a top engaging lip 311 projected inwardly toward the locking gripper 32 for gripping against the rear top edge of the top panel 111 so as to securely engage with the casing 11 and mount the electronic game device 10 on the handheld case gripper 20.

Furthermore, the front locking gripper 32 further comprises an operation lip 322 integrally and outwardly extended from the top edge of the locking gripper 32, so that the player may slightly push the locking gripper 32 away from the holder arms 31 by pressing the operation lip 322 outwardly, so as to disengage the locking ridge 321 with the engagement groove 113 by pulling the locking ridge 321 out of the engagement groove 113 and increase the distance between the locking gripper 32 and the holder arms 31 so that the player can detach the electronic game device 10 from the handheld case gripper 20.

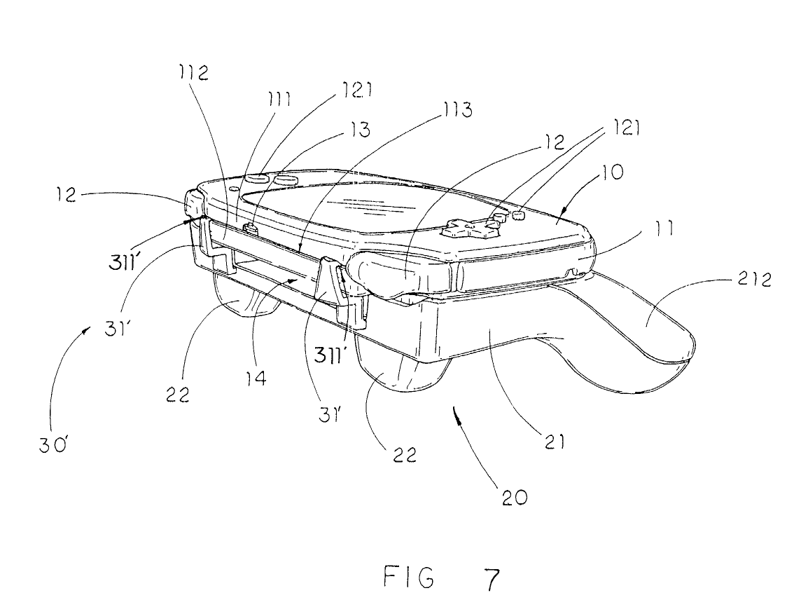

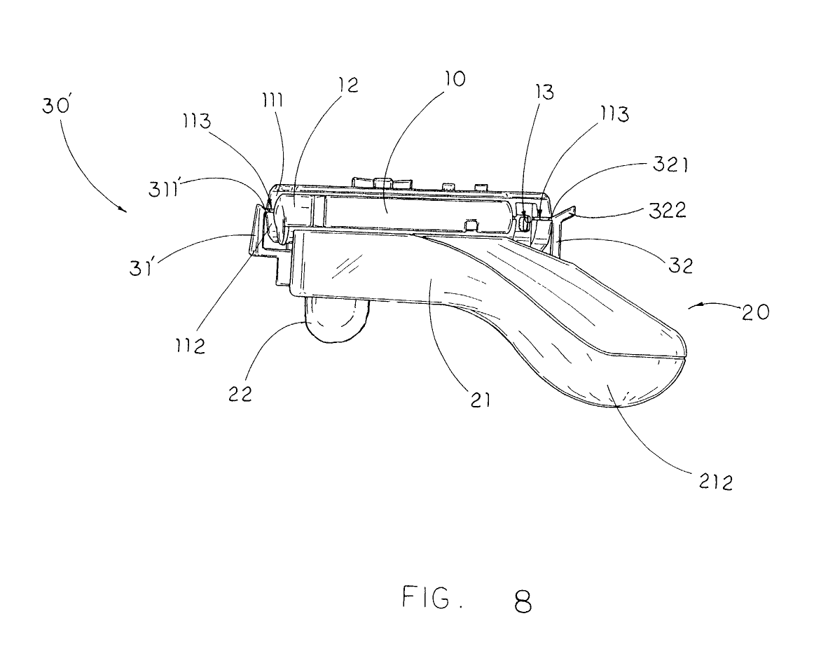

As shown in FIGS. 7 and 8, an alternative mode of the above preferred embodiment is illustrated in which, instead of providing the top engaging lips 311, each of the two rear holder arms 31′ of the interlocking arrangement 30′ of the present invention is alternatively embodied to not only integrally extend from a rear wall of the supporting holder 21, but also inwardly protrude an engaging ridge 311′ at a top edge thereof, wherein each of the engaging ridges 311′ has a thickness slightly smaller than the width of the engagement groove 113, so that when the two holder arms 31′ press on the rear side of the casing 11, the engaging ridge 311′ also fittingly engages into the engagement groove 113 of the casing 11. Accordingly, since both the holder arms 31′ and the locking gripper 32 are engaged with the casing 11 by inserting the engaging ridges 311′ and the locking ridge 321 into the engagement groove 113, both the front side and the rear side of the casing 11 are firmly gripped by the holder arms 31′ and the locking gripper 32 to prevent any upwardly movement so as to securely mount the electronic game device 10 on the handheld case gripper 20.

No matter which embodiments of holder arms 31, 31′ are used, the two holder arms 31 or 21′ are spacedly extended from the supporting holder 21 wherein a distance between the two holder arms 31 or 31′ is larger than a width of the card slot 14 but smaller than the distance between two side control buttons 12, so that a game card can still be inserted into the card slot 14 when the electronic game device 10 is mounted on the handheld case gripper 20. In other words, each upper holder arm 31 or 31′ grips on the casing 11 at a position between the respective side control button 12 and the card slot 14 so that the handheld case gripper 20 will not disturb the operation of the electronic game device 10 when the electronic game device 10 is mounted on the handheld case gripper 20.

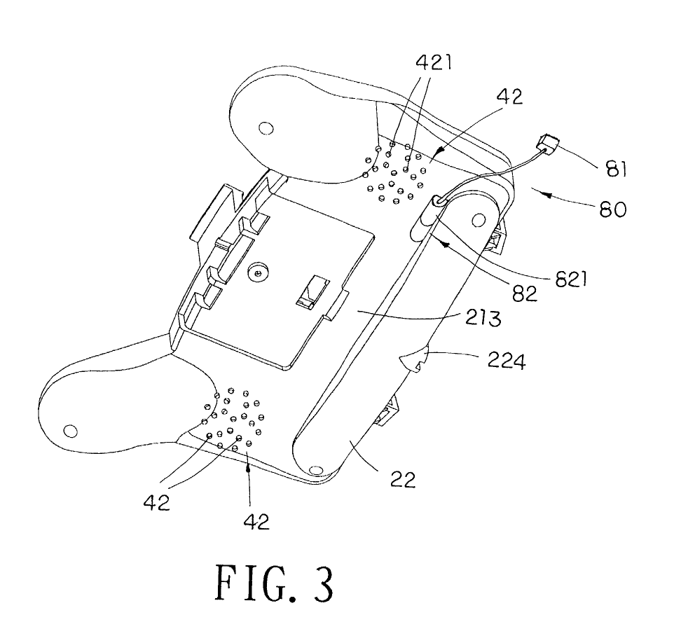

As shown in FIG. 3, the supporting platform 210 of the supporting holder 21 of the handheld case gripper 20 has a shape conformed with the shape of the electronic game device 10 and the receiving cavity 211 has a predetermined depth above the supporting platform 210 for receiving at least a bottom portion of the case of the electronic game device 10, wherein the two side control buttons 12, the device outlets 13, and a card slot 14 are exposed outside the receiving cavity 211 when the electronic game device 10 is mounted on the handheld case gripper 20, as shown in FIG. 1.

The two handle members 212 of the supporting holder 21 preferably has a bar-like shape adapted for being held by the palms of the player respectively so as to firmly and comfortably hold the electronic game device 10 when it is mounted on the handheld case gripper 20. Accordingly, the supporting holder 21 is preferably made of lightweight but durable material such as plastic that can be produced easily and economically by the molding techniques commonly known to those skilled in the art.

The gripping support 22 is integrally extended from a rear portion of a bottom surface of the supporting holder 21, wherein the gripping support 22 is adapted for being gripped by two middle fingers of the player so as to hold the electronic game device 10 which is mounted on the handheld case gripper 20. Therefore, the player is able to securely hold the handheld case gripper 20 by locking up the two gripping supports 22 with the two middle fingers so as to present the handheld case gripper 20 from being slipped out of the player's hands.

In other words, the handheld case gripper 20 and the electronic game device 10 mounted thereon can be well supported by holding the two handle members 212 in palms and gripping the two gripping supports 22 with the middle fingers, so that the player's two index fingers and two thumbs of the platter do not need to apply any significant force to support and hold the electronic game device 10 so that they are free to move for operating the side control buttons 12 and the top control buttons 121.

Moreover, the gripping support 22 is made to be a hollow body defining an indented chamber 221 at the rear portion of the bottom panel 112. The indented chamber 221 functions as a battery chamber having two battery terminals 222, 223 which are provided at two ends thereof respectively and electrically connected with the control board 60 which contains a battery recharging circuit, as shown in FIG. 4. At least a rechargeable battery 70 is received in the battery chamber (i.e. the indented chamber 221) with the electrode terminals thereof electrically connected with the battery terminals 222, 223 correspondingly.

According to the preferred embodiment of the present invention, two rechargeable batteries 70 are disposed in the battery chamber 221 to electrically connect with the battery recharging circuit of the control board 60. Correspondingly, the gripping support 22 comprises an external power inlet 222 electrically connecting the two rechargeable batteries 70 via the control board 60 and extended outside the gripping support 22 for providing a channel to charge up the two rechargeable batteries 70 disposed in the battery chamber 221.

On the other hand, as shown in FIG. 2, the handheld case gripper 20 further comprises a terminal connector 23 which is upwardly protruded from the supporting platform 210 of the receiving cavity 21 and adapted for being fittedly disposed in a battery compartment 15 of the electronic game device 10 after a cover 150 of the battery compartment 15 is removed. The terminal connector 23 comprises two terminals 231, 232 for electrically connecting the conductive terminals 151, 152 of the electronic game device 10 respectively, so as to supply electricity to the electronic game device 10 when the terminals 231, 232 are electrically connected to power supply. The two rechargeable batteries 70 are electrical connected with the two terminals 231, 232 of the terminal connector 23 to supply electrical power to the electronic game device 10 to function.

In other words, when the electronic game device 10 is detached from the handheld case gripper 20, the user may connect the external power inlet 224 with electricity power source, such as a wall socket, to charge up the rechargeable batteries 70. When the handheld case gripper 20 is in use, the electronic game device 10 mounted on the handheld case gripper 20 is powered by the two rechargeable batteries 70 inside the battery chamber 221. Also, according to the preferred embodiment, the control board 60 is designed to activate the recharging circuit thereof when the electronic game device 10 is detached from the handheld case gripper 20, i.e. the two terminals 231, 232 the terminal connector 23 is connected with nothing. However, when the electronic game device 10 is mounted on the handheld case gripper 20 with its conductive terminals 151, 152 are contacted with the two terminals 231, 232 of the terminal connector 23, the recharging circuit of the control board 60 is deactivated. Moreover, the electronic game device 10 can also be powered by an external power source by electrically connecting the external power source with the external power inlet 222 of the handheld case gripper 20.

Therefore, instead of providing batteries to the electronic game device 10, the electronic game device 10 can be operated by fittedly engaging its battery compartment 15 with the terminal connector 23 of the handheld case gripper 20. The electronic game device 10 is then operated by the rechargeable batteries 70 inside the battery chamber 221 of the handheld case gripper 20.

The two terminals 231 are mounted on the terminal connector 23 in such a manner that the two terminals 231 are biased against the two conductive terminals 171 in the battery compartment 15 respectively when the electronic game device 10 is mounted on the handheld case gripper 20.

Referring to FIGS. 2, 3 and 4 of the drawings, the audio device 40 according to the preferred embodiment of the present invention comprises a pair of speakers 41 which are installed at two sides within the storage cavity 214 and face towards the bottom panel 213, wherein two sound outlet portion 42 are formed on two sides of the bottom panel 213 of the supporting holder 21. Each of the sound outlet portion 42 has a plurality of sound meshes 421 perforated on the bottom panel 213 with respect to the position of the corresponding speaker 41, so that the sound waves generated by the two speakers 41 can be transmitted outside the storage cavity 214 through the sound meshes 421 of the two sound outlet portion 42 respectively.

The audio device 40 further comprises an audio input socket 43 and an audio connector 44, as shown in FIG. 2. The audio input socket 43 is provided on the supporting holder 21 for the pair of speakers 41 that communicates with an exterior of the supporting holder 21 for receiving audio signal from the electronic game device 10. The audio connector 44 is arrange to detachably connect the speakers 41 and the electronic game device 10, for provision of a channel which enables smooth transmission of audio signals from the electronic game device 10 to the pair of speakers 41.

According to the preferred embodiment of the present invention, the audio connector 44 comprises a L-shaped main body 441 and two audio plugs, namely a game device plug 442 and an audio device plug 443 extended from two ends of the main body 441 in such a manner that the two plugs 431, 432 are aligned with and adapted for plugging into an audio output slot 16 of the electronic game device 10 and the audio input socket 43 of supporting holder 21 respectively, so that the audio signals from the electronic game device 10 can be transmitted to the speakers 41 via the audio connector 44 and tile audio input socket 43.

In order to activate the audio device 40, the game device plug 431 is preferred to be plugged into the audio output slot 16 before the electronic game device 10 is engaged with the supporting holder 21. Then, the well-aligned audio device plug 432 can be fittedly and naturally plugged into the audio input socket 422 provided on the supporting holder 21 when the electronic game device 10 is engaged with the supporting holder 21. Then, the electronic game device 10 can transmit the digital audio signals to the speakers 41 via the audio connector 44. That is the pair of speakers 41 can generate any preprogrammed sound effect, such as stereo, from any particular game for the electronic game device 10.

Referring to FIGS. 4 and 5 of the drawings, the two vibrators 51 of the vibrating device 50 of the handheld case gripper 20 are securely supported inside the two handle cavities 2121 of the two handle members 212 respectively, wherein each of the vibrators 51 comprises a motor 511 and a bias wheel 512 connected to a shaft of the motor 511 so as to provide vibration when the bias wheel 512 is driven to rotate by the motor 511 to generate unbalanced centrifugal force. It produces the vibrating effect of the handle members 212.

The control board 60 is electrically connected to the two motors 511 of the vibrating device 50 for the purpose of activating them upon receiving vibrating signals from the electronic game device 10. Therefore, the handheld case gripper 20 further comprises a signal transmitting device 80 for transmitting signals from the electronic game device 10 to the control board 60 inside the storage cavity 214. The signal transmitting device 80 comprises a signal-receiving plug 81 movably extended from an auto-returning device 82, which is provided at the bottom surface of the handheld case gripper 20, as shown in FIG. 3, and adapted for plugging into the respective device outlet 13 the electronic game device 10. The auto-returning device 82 is electrically connected to the control board 60 of the handheld case gripper 20 so that any vibration signals outputted from the device outlet 13 can be transferred to the control board 60 via the signal receiving plug 81 and the auto-returning device 82.

Besides, the auto-returning device 82 comprises a retracting unit 821 connected to the signal receiving plug 81 so as to normally retain a major portion of signal receiving plug 82 inside the auto-returning device 82. When a player want to activate the vibrating device 50, the player has first to connect the vibrating device 50 to the respective device outlet 13 of the electronic game device 10 by pulling out the signal receiving plug 81 from the auto-returning device 82 and then plug the signal receiving plug 81 into the device outlet 13. When the player wants to deactivate the vibrating device 50, he/she can just simply unplug the signal receiving plug 81 from the device outlet 13 and then relief any holding force, the resilient element inside the retracting unit 821 will then automatically retract the signal receiving plug 81 to its original position, i.e. inside the auto-returning device 82.

What is claimed is:

1. A handheld case gripper for detachably attaching to an electronic game device having a battery compartment indented on a bottom side, wherein said handheld case gripper comprises:
a supporting holder comprising a supporting platform and a bottom panel which is combined with said supporting platform together to define a storage cavity between said supporting platform;
at least a handle member which is extended from said supporting holder having a handle cavity defined therein and communicated with said storage cavity;
an interlocking arrangement for holding said electronic game device on said supporting platform, wherein said interlocking arrangement comprises at least a holder arm and a locking gripper integrally and upwardly extended from a rear side and a front side of said supporting holder, adapted for holding said electronic game device firmly in position between said holder arm and said holding gripper by securely gripping said electronic game device;
a terminal connector upwardly protruded from said supporting platform of said supporting holder for being fitted in the battery compartment of the electronic game device, wherein said terminal connector comprises a predetermined number of terminals for electrically connecting a predetermined number of respective conductive terminals provided in the battery compartment of the electronic game device;
at least a rechargeable battery which is installed in said storage cavity of said supporting holder having two electrode terminals electrically connected with said terminals of said terminal connector; and
a power inlet provided on said supporting holder and electrically connected with said rechargeable battery for connecting an external power source to recharge said rechargeable battery.

2. The handheld case gripper, as recited in claim 1, wherein said supporting holder further has two side holding rims upwardly protruded from two peripheral sides of said supporting platform to define a receiving cavity between said two side holding rims on top of said supporting platform for fittedly receiving the electronic game device therein while said supporting platform substantially supports said weight of said electronic game device.

3. The handheld case gripper, as recited in claim 1, further comprising a control board installed inside said storage cavity of said supporting holder, wherein said control board which has a battery recharging circuit is electrically connecting with said power inlet, said rechargeable battery and said terminals of said terminal connector, wherein when the electronic game device is detached from said handheld case gripper, said external power inlet is able to be connected with the external power source to charge up said rechargeable battery, and that when said handheld case gripper is in use, the electronic game device mounted on said handheld case gripper is selectively powered either by said rechargeable battery or by said external power source while electrically connecting said external power source with said power inlet of said handheld case gripper.

4. The handheld case gripper, as recited in claim 3, further comprising a gripping support, which is integrally extended from a rear portion of said bottom panel of said supporting holder.

5. The handheld case gripper, as recited in claim 4, wherein said gripping support is made to be a hollow body defining an indented chamber at said rear portion of said bottom panel, wherein said indented chamber functions as a battery chamber having two battery terminals which are provided at two ends thereof respectively and electrically connected with said control board, wherein said rechargeable battery is received in said battery chamber with electrode terminals of said rechargeable battery electrically connected with said battery terminals correspondingly.

6. The handheld case gripper, as recited in claim 1, wherein said supporting holder further comprises another handle member frontwardly and downwardly extended from a front portion of said supporting holder, wherein each of said handle members has a handle cavity provided inside and communicated with said storage cavity.

7. The handheld case gripper, as recited in claim 6, further comprising a vibrating device which comprises two vibrators securely supported inside said two handle cavities of said two handle members respectively for producing vibrating effect of said two handle members.

8. The handheld case gripper, as recited in claim 7, wherein each of said vibrators comprises a motor and a bias wheel connected to a shaft of said motor so as to provide vibration when said bias wheel is driven to rotate by said motor to generate unbalanced centrifugal force that produces said vibrating effect of said handle members.

9. The handheld case gripper, as recited in claim 8, further comprising a signal transmitting device for transmitting signals from the electronic game device to said control board inside said storage cavity, wherein said control board is electrically connected to said two motors of said vibrating device for receiving vibrating signals from the electronic game device.

10. The handheld case gripper, as recited in claim 9, wherein said signal transmitting device comprises a signal-receiving plug movably extended from an auto-returning device and adapted for plugging into a device outlet of the electronic game device, wherein said auto-returning device is electrically connected to said control board of said handheld case gripper so that vibration signals outputted from said device outlet are transferred to said control board via said signal receiving plug and said auto-returning device.

11. The handheld case gripper, as recited in claim 5, wherein said supporting holder further comprises another handle member frontwardly and downwardly extended from a front portion of said supporting holder, wherein each of said handle members has a handle cavity provided inside and communicated with said storage cavity.

12. The handheld case gripper, as recited in claim 11, further comprising a vibrating device which comprises two vibrators securely supported inside said two handle cavities of said two handle members respectively for producing vibrating effect of said two handle members, wherein each of said vibrators comprises a motor and a bias wheel connected to a shaft of said motor so as to provide vibration when said bias wheel is driven to rotate by said motor to generate unbalanced centrifugal force that produces said vibrating effect of said handle members.

13. The handheld case gripper, as recited in claim 12, further comprising a signal transmitting device for transmitting signals from the electronic game device to said control board inside said storage cavity, wherein said control board is electrically connected to said two motors of said vibrating device for receiving vibrating signals from the electronic game device, wherein said signal transmitting device comprises a signal-receiving plug movably extended from an auto-returning device and adapted for plugging into a device outlet of the electronic game device, wherein said auto-returning device is electrically connected to said control board of said handheld case gripper so that vibration signals outputted from said device outlet are transferred to said control board via said signal receiving plug and said auto-returning device.

14. The handheld case gripper, as recited in claim 1, further comprising an audio device which comprises at least a speaker installed within said storage cavity, wherein at least a sound outlet portion having a plurality of sound meshes is formed on said supporting holder with respect to a position of said speaker, so that sound waves generated by said speaker are transmitted outside said storage cavity through said sound meshes.

15. The handheld case gripper, as recited in claim 14, wherein said audio device further comprises an audio input socket and an audio connector, wherein said audio input socket is provided on said supporting holder for speaker that communicates with an exterior of said supporting holder for receiving audio signals from the electronic game device, and said audio connector is arrange to detachably connect said speaker and said electronic game device, for provision of a channel which enables smooth transmission of said audio signals from the electronic game device to said speaker.

16. The handheld case gripper, as recited in claim 5, further comprising an audio device which comprises at least a speaker installed within said storage cavity, wherein at least a sound outlet portion having a plurality of sound meshes is formed on said supporting holder with respect to a position of said speaker, so that sound waves generated by said speaker are transmitted outside said storage cavity through said sound meshes.

17. The handheld case gripper, as recited in claim 16, wherein said audio device further comprises an audio input socket and an audio connector, wherein said audio input socket is provided on said supporting holder for said speaker that communicates with an exterior of said supporting holder for receiving audio signals from the electronic game device, and said audio connector is arrange to detachably connect said speaker and said electronic game device, for provision of a channel which enables smooth transmission of said audio signals from the electronic game device to said speaker.

18. The handheld case gripper, as recited in claim 10, further comprising a pair of speakers which are installed at two sides within said storage cavity and face towards said bottom panel, wherein two sound outlet portion are formed on two sides of said bottom panel of said supporting holder, wherein each of said sound outlet portion has a plurality of sound meshes perforated on said bottom panel with respect to said position of said corresponding speaker, so that sound waves generated by said two speakers are transmitted outside said storage cavity through said sound meshes of said two sound outlet portion respectively.

19. The handheld case gripper, as recited in claim 18, wherein said audio device further comprises an audio input socket and an audio connector, wherein said audio input socket is provided on said supporting holder for said pair of speakers that communicates with an exterior of said supporting holder for receiving audio signals from the electronic game device, and said audio connector is arrange to detachably connect said speakers and said electronic game device, for provision of a channel which enables smooth transmission of said audio signals from the electronic game device to said speakers.

20. The handheld case gripper, as recited in claim 13, further comprising a pair of speakers which are installed at two sides within said storage cavity and face towards said bottom panel, wherein two sound outlet portion are formed on two sides of said bottom panel of said supporting holder, wherein each of said sound outlet portion has a plurality of sound meshes perforated on said bottom panel with respect to said position of said corresponding speaker, so that sound waves generated by said two speakers are transmitted outside said storage cavity through said sound meshes of said two sound outlet portion respectively.

21. The handheld case gripper, as recited in claim 20, wherein said audio device further comprises an audio input socket and an audio connector, wherein said audio input socket is provided on said supporting holder for said pair of speakers that communicates with an exterior of said supporting holder for receiving audio signals from the electronic game device, and said audio connector is arrange to detachably connect said speakers and said electronic game device, for provision of a channel which enables smooth transmission of said audio signals from the electronic game device to said speakers.

22. The handheld case gripper, as recited in claim 1, wherein said interlocking arrangement comprises another holder arm, wherein said two holder arm are integrally and upwardly extended from a rear sidewall of said supporting holder and said locking gripper is integrally and upwardly extended from a front side wall of said supporting holder, thereby the electronic game device is firmly held in position between said holder arms and said locking gripper so as to securely grip the electronic game device on top of said supporting platform of said supporting holder.

23. The handheld case gripper, as recited in claim 22, wherein said front locking gripper is integrally extended from a front edge of said supporting holder and a front locking riddle is inwardly protruded from a top edge of said locking gripper towards said rear holder arms for fittingly engaging into a engagement groove of the electronic game device.

24. The handheld case gripper, as recited in claim 23, wherein each of said two holder arms of said handheld case gripper has a top engaging lip projected inwardly toward said locking gripper for gripping against a rear top edge of a top panel of the electronic game device.

25. The handheld case gripper as recited in claim 24, wherein each of said two holder arms has an engaging ridge inwardly protruded at a top edge thereof for fittingly engaging into a engagement groove of the electronic game device.

26. The handheld case gripper, as recited in claim 5, wherein said interlocking arrangement comprises another holder arm, wherein said two holder arm are integrally and upwardly extended from a rear sidewall of said supporting holder and said locking gripper is integrally and upwardly extended from a front side wall of said supporting holder, thereby the electronic game device is firmly held in position between said holder arms and said locking gripper so as to securely grip the electronic game device on top of said supporting platform of said supporting holder, wherein said front locking gripper is integrally extended from a front edge of said supporting holder and a front locking ridge is inwardly protruded from a top edge of said locking gripper towards said rear holder arms for fittingly engaging into a engagement groove of the electronic game device.

27. The handheld case gripper as recited in claim 26, wherein each of said two holder arms of said handheld case gripper has a top engaging lip projected inwardly toward said locking gripper for gripping against a rear top edge of a top panel of the electronic game device.

28. The handheld case gripper, as recited in claim 26, wherein each of said two holder arms has an engaging ridge inwardly protruded at a top edge thereof for fittingly engaging into a engagement groove of the electronic game device.

29. The handheld case gripper, as recited in claim 10, wherein said interlocking arrangement comprises another holder arm, wherein said two holder arm are integrally and upwardly extended from a rear sidewall of said supporting holder and said locking gripper is integrally and upwardly extended from a front side wall of said supporting holder, thereby the electronic game device is firmly held in position between said holder arms and said locking gripper so as to securely grip the electronic game device on top of said supporting platform of said supporting holder, wherein said front locking gripper is integrally extended from a front edge of said supporting holder and a front locking ridge is inwardly protruded from a top edge of said locking gripper towards said rear holder arm is for fittingly engaging into a engagement groove of the electronic game device.

30. The handheld case gripper, as recited in claim 29, wherein each of said two holder arms of said handheld case gripper has a top engaging lip projected inwardly toward said locking gripper for gripping against a rear top edge of a top panel of the electronic game device.

31. The handheld case gripper, as recited in claim 29, wherein each of said two holder arms has an engaging ridge inwardly protruded at a top edge thereof for fittingly engaging into a engagement groove of the electronic game device.

32. The handheld case gripper, as recited in claim 15, wherein said interlocking arrangement comprises another holder arm, wherein said two holder arm are integrally and upwardly extended from a rear sidewall of said supporting holder and said locking gripper is integrally and upwardly extended from a front side wall of said supporting holder, thereby the electronic game device is firmly held in position between said holder arms and said locking gripper so as to securely grip the electronic game device on top of said supporting platform of said supporting holder wherein said front locking gripper is integrally extended from a front edge of said supporting holder and a front locking ridge is inwardly protruded from a top edge of said locking gripper towards said rear holder arms for fittingly engaging into a engagement groove of the electronic game device.

33. The handheld case gripper, as recited in claim 32, wherein each of said two holder arms of said handheld case gripper has a top engaging lip projected inwardly toward said locking gripper for gripping against a rear top edge of a top panel of the electronic game device.

34. The handheld case gripped as recited in claim 32, wherein each of said two holder arms has all engaging ridge inwardly protruded at a top edge thereof for fittingly engaging into a engagement groove of the electronic game device.

35. The handheld case gripper, as recited in claim 21, wherein said interlocking arrangement comprises another holder arm, wherein said two holder arm are integrally and upwardly extended from a rear sidewall of said supporting holder and said locking gripper is integrally and upwardly extended from a front side wall of said supporting holder, thereby the electronic game device is firmly held in position between said holder arms and said locking gripper so as to securely grip the electronic game device on top of said supporting platform of said supporting holder, wherein said front locking gripper is integrally extended from a front edge of said supporting holder and a front locking ridge is inwardly protruded from a top edge of said locking gripper towards said rear holder arms for fittingly engaging into a engagement groove of the electronic game device.

36. The handheld case gripper, as recited in claim 35, wherein each of said two holder arms of said handheld case gripper has a top engaging lip projected inwardly toward said locking gripper for gripping against a rear top edge of a top panel of the electronic game device.

37. The handheld case gripper, as recited in claim 35, wherein each of said two holder arms has an engaging ridge inwardly protruded at a top edge thereof for fittingly engaging into a engagement groove of the electronic game device.
